(19) United States
(12) Patent Application Publication
(10) Pub. No.: US 2025/0222713 A1
(43) Pub. Date: Jul. 10, 2025

(54) WATER-BASED DE-METALLIZATION RESIST

(71) Applicant: SUN CHEMICAL B.V., LV Weesp (NL)

(72) Inventors: Robert MCHARDY, Harlow, Essex (GB); Aaron WILSON, Harlow, Essex (GB)

(73) Assignee: SUN CHEMICAL B.V., LV Weesp (NL)

(21) Appl. No.: 18/727,769

(22) PCT Filed: Feb. 7, 2023
(86) PCT No.: PCT/GB2023/050270

§ 371 Date: Jul. 10, 2024

(30) Foreign Application Priority Data
Feb. 7, 2022 (GB) 2201538.2

(51) Int. Cl. B42D 25/355; B42D 25/29; B42D 25/328; B42D 25/373; B42D 25/378; C09D 11/037; C09D 11/107

(52) U.S. Cl. CPC B42D 25/355; B42D 25/29; B42D 25/328; B42D 25/373; B42D 25/378; C09D 11/037; C09D 11/107

(57) ABSTRACT

The present invention relates to a method of protecting a metal surface from damage or removal during an alkaline de-metallization process, comprising printing a water-based resist composition onto a metal-coated filmic substrate, thereby protecting the metal surface from damage or removal during the de-metallization process, wherein the water-based resist composition comprises a cationic acid-soluble resin or cationic acid-stabilized resin and water.

The present invention relates to a water-based composition that is suitable for use as a de-metallization resist in alkaline de-metallization processing. Advantageously, the primary solvent of the resist composition described herein is water and it therefore has improved sustainability and reduced environmental impact compared to solvent-based resists. Moreover, the water-based resist compositions do not sacrifice the de-metallization quality.

### BACKGROUND OF THE INVENTION

U.S. Pat. No. 4,652,015 (Crane Company)—refers to de-metallized security threads. A resist and etch process is described. The use of a caustic resistive ink varnish is mentioned but the formulation or other properties of such a varnish are not disclosed.

EP0319157 (Portals Ltd) refers to de-metallized security threads. A resist and etch process is described but the formulation of the resist ink is not disclosed. EP0319157 also mentions addition of a fluorescent dye to the resist but gives no further teaching on the resist formulation.

EP0987599 (Fabriano Securities SRL) refers to an alternative method for de-metallization which uses a UV curable mask.

WO2009027771 (Fabriano Securities SRL) mentions use of a resist ink based on nitrocellulose, but in reference to etching with acids.

U.S. Pat. No. 4,242,378A (Reiko Co Ltd) refers to a method of making a decorated film with a metal layer in the form of a given pattern. It mentions the use of a water insoluble resin, which includes general hydrophobic resins such as polyurethane polyamide, polyacrylate, polyester and the like. This patent refers to general packaging films, and these technologies are not suitable for security applications.

U.S. Pat. No. 9,975,370 (OVD Kinegram AG) refers to the de-metallization process as applied to the production of a multi-layer body, in particular a security element. It mentions the use of an etch resist. The etch resist is preferably a lacquer, which can in particular comprise binders, dyes, pigments, in particular colored or non-colored pigments, effect pigments, thin-film layer systems, cholesteric liquid crystals and/or metallic or non-metallic nanoparticles. The partial lacquer layer thus not only fulfils a protective function during the structuring of the metal layer but can itself display a decorative effect. It is also possible for several different etch resists, for example resist lacquers with different colorations, to be used in order to produce further visual effects. Etch resists based on PVC (polyvinyl chloride), polyester resins or acrylates are described as suitable where acidic etching media is used, wherein typically further film-forming substances such as nitrocellulose can be mixed in. Those skilled in the art will understand that this refers to solvent-based lacquer formulations. U.S. Pat. No. 9,975,370 does not disclose water-based resist formulations.

The selective removal of aluminum from metallized PET (polyethylene terephthalate), in patterns or indicia, is well known in the art as a method of increasing the counterfeit resistance and aesthetic appeal of security threads and holographic stripes and patches for banknotes (or currency notes) or other documents of value.

Although selective removal of aluminum from metallized PET is also more broadly known as a method of making decorated films which are used for packaging, decorations or other non-secure applications, there are specific requirements where these materials are used in documents of value. In particular, there are very precise requirements for accurate de-metallization and edge definition due to the narrow stem widths (e.g. 50-100 microns) of the indicia and other patterns used in this application. These are required to produce complex products which are highly resistant to counterfeiting. Therefore, technologies which may be suitable more generally for packing etc. are not suitable for products for documents of value.

The selective removal of aluminum is commonly achieved by gravure or flexo printing a transparent or tinted resist ink onto the aluminum surface and then de-metallizing using sodium hydroxide solution, for example, as described in U.S. Pat. No. 4,652,015 and EP0319157. The resist ink needs to be fast drying and immediately resistant to sodium hydroxide solution. The resist ink also needs to be block resistant so that it does not cause blocking when the coated substrate is reeled up in a roll-to-roll process. The resist ink needs to be suitable for printing in a high-speed gravure or flexo or screen process with a satisfactory print quality and acceptable foaming levels. Solvent based liquid inks (e.g., with a viscosity<10 Pa·s) meet these requirements very well. However, solvent-based inks have poor sustainability and are not environmentally friendly.

There is a need for water-based resists due to health, safety and environmental concerns regarding solvent-based inks. The key technical challenge is that the printed resist needs to be immediately resistant to strong alkalis such as NaOH. Conventional water-based coatings such as anionic acrylates and polyurethanes being essentially alkaline soluble are not sufficiently resistant. The inventors have discovered that cationic acrylic solutions are suitable for this application as they are alkaline resistant. With proper formulation the inventors have been able to develop a block resistant, low foaming water-based ink system, particularly suitable for gravure printing.

Citation or identification of any document in this application is not an admission that such represents prior art to the present invention.

### DETAILED DESCRIPTION

The present invention provides a method of protecting a metal surface from damage or removal during a de-metallization process, comprising printing a water-based resist composition onto a metal-coated filmic substrate, thereby protecting the metal surface from damage or removal during the de-metallization process, wherein the water-based resist composition comprises a cationic acid-soluble resin or cationic acid-stabilized resin, and water. Preferably, the filmic substrate is aluminum-coated, i.e., the metal coating on the filmic substrate is an aluminum coating. Preferably, the de-metallization process is an alkaline de-metallization process.

Preferably, the present invention provides a method of protecting a metal surface from damage or removal during an alkaline de-metallization process, comprising printing a water-based resist composition onto a metal-coated filmic substrate, thereby protecting the metal surface from damage or removal during the de-metallization process, wherein the water-based resist composition comprises a cationic acid-soluble resin and a cationic acid-stabilized resin, and water. Preferably, the filmic substrate is aluminum-coated, i.e., the metal coating on the filmic substrate is an aluminum coating. Preferably, the de-metallization process is an alkaline de-metallization process.

The present invention also provides a method of printing on a metal-coated filmic substrate wherein said method comprises applying a water-based composition onto the substrate, wherein the water-based composition comprises a cationic acid-soluble resin or a cationic acid-stabilized resin and water, wherein the printing is gravure, flexographic or screen printing. Preferably, the metal-coated filmic substrate is an aluminum-coated filmic substrate. Preferably, printing is by gravure printing.

Preferably, the methods of the present invention do not comprise exposing the resist composition to actinic or infrared (IR) radiation. Preferably, the methods of the present invention do not comprise exposing the resist composition to actinic or infrared (IR) radiation for altering the polymeric crosslinking density of the cationic acid-soluble resin or cationic acid-stabilized resin. More preferably, the methods of the present invention do not comprise exposing the resist composition to actinic or IR radiation to achieve the required resistance properties during de-metallization. As will be understood by the skilled person, exposure to IR for the purpose of achieving the required resistance properties does not exclude exposure to IR for the purpose of heating.

The present invention also provides a water-based resist composition comprising: a cationic acid-soluble resin or cationic acid-stabilized resin; and water; wherein the composition is suitable for use as a resist in alkaline de-metallization processing. Preferably, the present invention also provides a water-based resist composition comprising: a cationic acid-soluble resin and cationic acid-stabilized resin; and water; wherein the composition is suitable for use as a resist in alkaline de-metallization processing. Preferably, the cationic acid-stabilized resin has a Tg of ≥50° C.

The present invention also provides a water-based resist composition suitable for use as a resist in alkaline de-metallization processing, said composition comprising: a cationic acid-soluble resin or cationic acid-stabilized resin; and water; wherein the composition is not a photoresist activated by actinic or infrared radiation, and wherein the composition does not comprise a crosslinking agent. Preferably, the present invention provides a water-based resist composition suitable for use as a resist in alkaline de-metallization processing, said composition comprising: a cationic acid-soluble resin and a cationic acid-stabilized resin; and water; wherein the composition is not a photoresist activated by actinic or infrared radiation, and wherein the composition does not comprise a crosslinking agent.

The present invention also provides use of a water-based resist composition for protecting a metal surface from damage or removal during a de-metallization process of a metal-coated filmic substrate, wherein the water-based resist composition comprises water and a cationic acid-soluble resin or acid-stabilized resin.

The present invention also provides a printed article prepared by the method described herein. Preferably, the printed article is a security device, more preferably a security thread, tape or hologram.

The present invention also provides a security article comprising the security device described herein, preferably wherein the security article is a banknote.

The present invention also provides a security device comprising a metal-coated filmic substrate wherein the metal-coated filmic substrate comprises a resist layer derived from a water-based composition as described herein.

The prior art does not disclose a water-based resist composition according to the present invention that is suitable for alkaline de-metallization.

Advantages of the present invention include:
Water-based non-flammable ink system;
Low volatile organic compounds (VOCs);
No requirement for crosslinkers;
Immediate de-metallization is possible;
High quality de-metallization is achieved; and
Improved sustainability

The present invention describes a water-based cationic ink system designed for printing onto metal-coated (e.g. aluminum-coated) filmic substrates for the purpose of protecting the metal (e.g. aluminum) surface from damage or removal during an alkaline de-metallization process in the areas printed with the ink.

The resist compositions of the present invention are not photoresists. In particular, the resist compositions of the present invention are distinguished from photoresist compositions as they do not require exposure to actinic or infrared (IR) radiation to achieve the required resistance properties during de-metallization (i.e., the resist compositions of the present invention are not activated by actinic or infrared radiation). As such they preferably do not include photoinitiators and/or IR-absorbing materials.

Preferably, the compositions of the present invention do not comprise a photoinitiator selected from a thioxanthone, phosphine oxide, quinine, benzophenone, benzoin, acetophenone, benzoin ether and/or benzil ketal. More preferably, the compositions of the present invention do not comprise any photoinitiator. As will be understood in the art, acetophenone photoinitiators include, for example, hydroxyl- and aminoacetophenones such as 2-hydroxy-2-methyl propiophenone.

Preferably, the compositions of the present invention do not comprise an IR-absorbing material selected from: carbon black and/or graphite in an amount of 5 to 50 wt % of the total weight of the composition; and/or organic compound(s) selected from poly-(substituted)-phthalocyanine compounds, cyanine dyes, squarylium dyes, chalcogenopyryloarylidene dyes, bis-(chalcogenopyrylo)polymethine dyes, oxyindolizine dyes, bis(aminoaryl)polymethine dyes), merocyanine dyes, quinoid dyes, indolenine dyes, indocyanine dye and a combination thereof in an amount of 0.1 to 10 wt % of the total weight of the composition, or wherein the composition does not contain said IR absorbing materials in any amount. More preferably, the compositions of the present invention do not comprise any IR-absorbing materials.

Given that the resist compositions of the present invention are not photoresist compositions they do not require photoactive polymers such as 2,6-dinitro-1.4-bis(dichloromethyl)benzene. Accordingly, the compositions of the present invention preferably do not comprise photoactive polymers such as 2,6-dinitro-1.4-bis(dichloromethyl)benzene.

The ink system is preferably comprised of an aqueous cationic polymer solution, modified where required with a cationic emulsion polymer. The change to a water-based ink system from a solvent-based ink system greatly reduces the amount of volatile organic compounds released when printing. The cationic technology is acid-stabilized, requiring a pH preferably below 7 to retain aqueous stability. This allows the ink to retain excellent resolubility on press but provides inherent alkaline resistance as soon as the ink is dry, allowing it to resist the strong alkalis used in the de-metallization process. Typically these alkalis are aqueous group one metal hydroxide solutions with a pH≥13. As the resistance is achieved in the drying process, this allows the printing and de-metallization process to be carried out in-line, rather than requiring the print to be stored and demetallized at a later date.

### Definitions

Water based: A water-based ink is one where the primary solvent is water (i.e. at least 50% by weight of the ink solvent system is water). Preferably, the composition of the present invention comprises a solvent system that is at least 50% by weight water, more preferably at least 65% by weight water.

Volatile organic compound (VOC): any organic compound as well as the fraction of creosote, having a vapor pressure of 0.01 kPa or more at 20° C., or having a corresponding volatility under the particular conditions of use.

Resolubility: The ability of an ink to redissolve itself.

Cationic ink system: An ink system containing an acid-soluble or acid-stabilized component or resin. A cationic ink system may also contain an acid-soluble and an acid-stabilized component or resin. A typical acid-soluble polymer would be a poly(amino alkyl acrylate) or poly(amino alkyl methacrylate) such as a terpolymer of ethyl acrylate, methyl methacrylate, and dimethyl amino ethylmethacrylate (EA/MMA/DMAEMA terpolymer), for example containing approximately 34% of EA, 37% of MMA and 19% of DMAEMA by weight. DMAEMA is an amine functional acrylic monomer which, when in the terpolymer and neutralized to a pH of about 5.0, is protonated, and carries a positive charge (i.e. is quaternized).

An acid-soluble resin or acid-soluble polymer: a polymer typically comprising functional groups capable of being protonated with an acid as part of their chemical structure. Where the functional groups of the polymer are protonated, the polymer can then be dissolved in water to form an aqueous solution.

As used herein, a cationic acid-stabilized resin (or a cationic acid-stabilized polymer) is also referred to as a cationic emulsion polymer.

As used herein, the term “cationic emulsion polymer” typically refers to a cationic polymer suspended in liquid medium to provide an emulsion. Typically the resulting cationic emulsion may be stabilized by an acid-soluble polymer or a protonated surfactant carrying a positive charge. Preferably, the cationic emulsion polymer has a glass transition temperature≥50° C. More preferably, the cationic emulsion polymer has a Tg≥80° C. Without being bound in this regard it is hypothesized that cationic emulsion polymers having a Tg≥50° C. improve the block resistance of the resist composition, which is advantageous for flexographic, gravure and screen printing.

Preferably, the cationic acid-soluble resin is solubilized with acetic acid and/or formic acid. Preferably, the cationic acid-soluble resin a cationic acid-soluble acrylic resin.

Preferably, the cationic emulsion polymer is a cationic acrylic resin emulsion. More preferably, the cationic emulsion polymer is a cationic acrylic resin emulsion having a Tg≥50° C. More preferably still, the cationic emulsion polymer is a cationic acrylic resin emulsion having a Tg≥80° C.

Metal-coated (e.g. aluminum-coated) filmic substrates: A flexible polymeric surface or film, upon which a layer of metal (e.g. aluminum) has been deposited. This layer may be modified by further deposition of other metals and oxides to create, for example, colored effects with an angular component. Typical usage examples could include, but are not restricted to, metallized PET, holograms, and color shift substrates. De-metallization process: The process by which unprotected metal (e.g. aluminum) is removed from coated filmic substrates, by reaction with an alkaline reagent.

Resist composition: As used herein a resist composition is used to protect at least a portion of a surface coated with metal from damage or metal_removal during a de-metallization process. The resist composition according to the present invention is not a photoresist.

Preferably, the water-based resist composition is a water-based cationic ink system.

Preferably, the water-based resist composition of the present invention does not comprise a nitrocellulose resin.

The resist compositions of the present invention (which are not photoresists) do not require crosslinking either by chemical reaction of by exposure to UV light.

The water-based resist composition according to the present invention does not comprise any crosslinkers (i.e. crosslinking agents). Crosslinking agents include, but are not limited to, melamine-formaldehyde resins, zinc oxide, carbodiimide, cupric oxide, magnesium oxide, calcium oxide, glutaraldehyde, glyoxal, borates, potassium persulfate, aluminum chloride, titanium tetrahydrochloride, zinc chloride, aziridine compounds or any combination thereof. Hence, the water-based resist composition according to the present invention does not comprise a crosslinker selected from melamine-formaldehyde resins, zinc oxide, carbodiimide, cupric oxide, magnesium oxide, calcium oxide, glutaraldehyde, glyoxal, borates, potassium persulfate, aluminum chloride, titanium tetrahydrochloride, zinc chloride, aziridine compounds or any combination thereof.

Preferably, the water-based resist composition of the present invention has a print viscosity of 15 to 35 seconds (Zahn cup #2), preferably 20 to 30 seconds (Zahn cup #2).

Preferably, the total amount of said cationic acid-soluble resin and/or cationic acid-stabilized resin in the compositions of the present invention is in the range from 10 to 50% by weight, more preferably 15 to 40% by weight, relative to the total weight of the composition.

### Waxes

The printing ink may also include waxes such as but not limited to amide wax, erucamide wax, polypropylene wax, paraffin wax, polyethylene wax, teflon, carnuba wax and the like. The wax may be a combination of said waxes.

### Additives

As with most ink and coating compositions, additives may be incorporated to enhance various properties. A partial list of such additives includes but is not limited to adhesion promoters, light stabilizers, de-gassing additives, flow promoters, defoamers, antioxidants, stabilizers, surfactants, wetting aids, dispersants, plasticizers, rheological additives, etc. Preferably, the composition of the present invention comprises a defoamer (i.e., defoaming agent). More preferably, the composition of the present invention comprises a defoamer that is not a polysiloxane.

As will be understood in the art, alcohols such as ethanol may function as defoaming agents. Preferably, the composition of the present invention comprises one or more C₁₋C₄ alcohol(s), preferably methanol and/or ethanol, more preferably ethanol. Where used, the C₁₋C₄ alcohol(s) is preferably used in 0.1 to 10 wt % of the composition, more preferably 0.1 to 5 wt % of the composition.

Preferably, the composition comprises a wetting aid, preferably a non-ionic organic wetting aid, more preferably a silicone-free non-ionic organic wetting aid. A suitable silicone-free non-ionic organic wetting aid that may be used is Tego-Wet 500 (Evonik).

Where used, the surfactant is preferably present in 0.1 to 2 wt % of the composition.

### Extenders

The compositions and inks of this invention may contain the usual extenders such as clay, talc, calcium carbonate, magnesium carbonate or silica to adjust gloss, transparency, tack and color strength.

### Solvents

In addition to water, miscible alcohol functional solvents, glycol ethers and acetals, may be added to adjust solubility, drying speed and surface tension. It is preferred that, where used, any organic solvent (such as alcohol functional solvents, glycol ethers and acetals) are present in no more than 30 wt % of the composition.

### Colorants

The compositions of the present invention may further comprise a colorant.

The colorant may be any pigment that can be employed in printing inks. It may be organic or inorganic and may be a dye or pigment. Typical examples of useable colorants include, but are not limited to, inorganic pigments, such as Pigment White 6 (Titanium Dioxide), Pigment Black 7 (carbon black), Pigment Black 11 (Black Iron Oxide), Pigment Red 101 (Red Iron Oxide) and Pigment Yellow 42 (Yellow Iron Oxide), and organic pigments such as Pigment Yellow 1, Pigment Yellow 3, Pigment Yellow 12, Pigment Yellow 13, Pigment Yellow 14, Pigment Yellow 17, Pigment Yellow 37, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 112, Pigment Red 146, Pigment Red 170, Pigment Red 196, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment Violet 23 and the like.

Suitable inorganic pigments include, but are not limited to, carbon black and titania (TiO₂), while suitable organic pigments include, but are not limited to, phthalocyanines, anthraquinones, perylenes, carbozoles, monoazo- and disazobenzimidazolones, isoindolinones, monoazonaphthols, diarylidepyrazolones, rhodamines, indigoids, quinacridones, diazopyranthrones, dinitranilines, pyrazolones, dianisidines, pyranthrones, tetrachloroisoindolinones, dioxazines, monoazoacrylides, and anthrapyrimidines. It will be recognized by those skilled in the art that organic pigments are differently shaded, or even have different colors, depending on the functional groups attached to the main molecule.

Preferably, the composition of the present invention comprises titanium dioxide as colorant.

Security pigments and dyes that are luminescent, phosphorescent, anti-stokes upconverters, IR absorbing, ramen active and magnetic may also be used in the present invention.

The dyes include but are not limited to azo dyes, anthraquinone dyes, xanthene dyes, azine dyes, combinations thereof and the like.

Where used, the colorant is present in 5 to 40 wt % of the ink composition, more preferably 15 to 30 wt % of the ink composition.

### Printing

Printing may be performed by gravure printing, flexographic printing, screen printing, spray coating, ink jet printing, lithographic printing, roll coating, curtain coating, etc. The compositions of the present invention are particularly suitable for high speed printing using flexography, gravure or screen printing. Preferably, the print method for the present invention is flexography, gravure printing or screen printing, more preferably gravure printing.

### Substrates

Preferably, the substrates used in the present invention are metal-coated polymeric films, more preferably aluminum-coated polymeric films. The metal coating (preferably aluminum coating) may be present as a single layer on the polymeric film. Alternatively, the metal-coated polymeric film (preferably aluminum-coated polymeric film) may be further coated with other materials. For example, the metal-coated polymeric film (preferably aluminum-coated polymeric film) may be further coated to give an interference color.

Suitable polymeric films include polyesters, polypropylene, polyethylene and nylon. Preferably, the polymeric film is a polyester film, more preferable a polyethylene terephthalate (PET). Most preferably, the substrate used in the present invention is aluminum-coated PET.

A security article may be selected from security documents, bonds, share certificates, stamps, tax receipts, identification documents (such as passports), security tags, security badges and banknotes. Preferably the security article is in the form of a sheet, particularly a banknote or security document, and preferably the security article is a banknote.

Examples 4 & 5 are based on cationic resin technology. The ink system retains solubility by means of a salt formed between the resin and a neutralizing acid and is insoluble in alkaline conditions. This provides inherent alkaline resistance sufficient to provide adequate demetallation resistance.

### Measurement Methods

Glass transition temperature (Tg): Unless stated otherwise, glass transition temperature is measured by differential scanning calorimetry (DSC). Preferably, measurements were made according to the following standard test method and based on the method described in ASTM E1356-98. The sample was maintained under an atmosphere of dry nitrogen for the duration of the scan. A flow rate of 20 ml/min and Al pans were used. Samples (5 mg) were heated at 20° C./min from 20° C. to 350° C. The value of a Tg was determined as the extrapolated onset temperature of the glass transition observed on the DSC scans (heat flow (W/g) against temperature (° C.)), as described in ASTM E1356-98.

Viscosity: Unless stated otherwise, viscosity was measured at 23° C. in using Zahn cup #2 in accordance with ASTM D4212-16.

pH: Unless stated otherwise, pH is measured at 25° C. using an Oakton 510 series pH meter.

The present invention is further described in the following numbered paragraphs.
1. A water-based resist composition comprising:
   a cationic acid-soluble or acid-stabilized resin; and water;
   wherein the composition is suitable for use as a resist in alkaline de-metallization processing.
2. The composition of paragraph 1, further comprising a colorant or extender.
3. The composition of paragraph 1, further comprising a cationic emulsion.
4. The composition of paragraph 3, wherein the cationic emulsion has a Tg≥50° C.
5. The composition of any preceding paragraph, further comprising a wetting aid.
6. A method of protecting a metal surface from damage or removal during a de-metallization process, comprising printing the composition of any of paragraphs 1-5 onto a metal-coated filmic substrate, thereby protecting the metal surface from damage or removal during the de-metallization process.
7. The method of paragraph 6, wherein the filmic substrate is aluminum-coated.
8. A method of de-metallization, comprising following the method of paragraphs 6 or 7, then subjecting the metal-coated filmic substrate to an alkaline de-metallization process.
9. A security thread, tape or hologram resulting from the method any of paragraphs 6-8.
10. A banknote or other security document comprising the thread, tape or hologram of paragraph 9.

The present invention has been described in detail, including the preferred embodiments thereof. However, it will be appreciated that those skilled in the art, upon consideration of the present disclosure, may make modifications and/or improvements on this invention that fall within the scope and spirit of the invention.

### EXAMPLES

The invention is further described by the following non-limiting examples which further illustrate the invention, and are not intended, nor should they be interpreted to, limit the scope of the invention.

### Example 1 (Comparative): Formulation of Solvent-Based Colorless Ink

| Material | % |
|---|---|
| Ethanol | 60 |
| nPropyl Acetate | 20 |
| Nitrocellulose | 16 |
| Plasticizer | 4 |
| Total | 100 |

Solvent based nitrocellulose resist ink. Gives adequate performance but has high VOC.

### Example 2 (Comparative): Formulation of Water-Based Colorless Anionic Acrylic Ink

| Material | % |
|---|---|
| Anionic carboxylated styrene acrylic resin | 34.3 |
| solution | |
| Low Tg anionic acrylic emulsion resin | 51.4 |
| PE wax dispersion | 5.1 |
| Polysiloxane defoamer | 0.3 |
| Water | 5.0 |
| Propanol | 3.9 |
| Total | 100 |

Conventional water-based anionic ink for flexible substrates. Very poor de-metallization resistance due to poor alkali resistance.

### Example 3 (Comparative): Formulation of Water-Based Colorless 2 Pack Anionic Acrylic Ink

| Material | % |
|---|---|
| Anionic Carboxylated styrene acrylic resin | 33.6 |
| solution | |
| Low Tg¹ anionic acrylic emulsion resin | 50.4 |
| PE wax dispersion | 5.0 |
| Polysiloxane defoamer | 0.3 |
| Water | 4.8 |
| Propanol | 3.9 |
| Crosslinker CX 100 | 2.0 |
| Total | 100 |

¹Tg of <0° C.

Water based anionic ink for flexible substrates, crosslinked with an aziridine to provide alkali resistance. The crosslinked ink has a short pot life, meaning that the cross-linker must be added press side. This is not suitable for an inline process, as the crosslinking reaction takes time to develop the required alkali resistance in order to provide adequate demetallation resistance.

### Inventive Example 4: Water-Based White Ink

| Material | % |
|---|---|
| Aqueous cationic acrylic resin solution¹ | 60.8 |
| Titanium dioxide | 26.3 |
| Water | 8.0 |
| TEGO ® Wet 500 | 0.9 |
| Ethanol | 4.0 |
| Total | 100.0 |

¹Poly(amino alkyl methacrylate) solution with 30% by weight polymer.

### Inventive Example 5: Water-Based Colorless Ink

| Material | % |
|---|---|
| Aqueous cationic acrylic resin solution¹ | 36.9 |
| Cationic acrylic resin emulsion² | 55.4 |
| Water | 2.7 |
| TEGO ® Wet 500 | 1.0 |
| Ethanol | 4.0 |
| Total | 100.0 |

¹Poly(amino alkyl methacrylate) solution with 30% by weight cationic polymer.
²Acid-stabilised cationic resin aqueous emulsion with 40% by weight polymer; Tg of >50° C.

Examples 4 & 5 are based on cationic resin technology. The ink system retains solubility by means of a salt formed between the resin and a neutralizing acid and is insoluble in alkaline conditions. This provides inherent alkaline resistance sufficient to provide adequate demetallation resistance.

### Sample Preparation:

All examples were prepared using a Silverson L5 rotor-stator mixer, using a 50 mm stator and a 35 mm collar pierced with 10 mm holes. The colorless inks were mixed at 2000 rpm for 10 minutes, while the white ink was mixed at 3000 rpm for 15 minutes. The inks were cooled to room temperature and the viscosity reduced to 27 second (Zahn cup #2 tested in accordance with ASTM D4212), by addition of the primary solvent used in the ink.

TABLE 1
Test Results

| | Comp. | Comp. | Comp. | Inv. | Inv. |
|---|---|---|---|---|---|
| Ink tests | Ex. 1 | Ex. 2 | Ex. 3 | Ex. 4 | Ex. 5 |
| Printability | 5 | 4 | 4 | 4 | 4 |
| Resolubility | 5 | 5 | 4 | 5 | 5 |
| Block Resistance | 5 | 5 | 5 | 5 | 5 |
| Foam Control | 5 | 4 | 4 | 4 | 4 |
| Adhesion | 4 | 3 | 4 | 4 | 4 |
| Cure time | 5 | 1 | 2 | 5 | 5 |
| De-metallization Quality | 4 | 1 | 3 | 4 | 4 |
| VOC Emissions | 1 | 4 | 4 | 4 | 4 |

The examples were graded 1 to 5 for each property with 5 being very good and 1 very poor (see grading systems for each property below). As can be seen in Table 1, Inventive Examples 4 & 5 exhibited similar or better properties than Comparative Examples 1-3.

All print tests were carried out on prints prepared using a RK gravure flatbed printer, using a 150 LPI (lines per inch) stepped plate, speed 5, printing onto the aluminum side of Metalized PET. Though the preferred print method for the present application is gravure, it is understood that the inks/coatings could be formulated for printing by flexographic, screen, spray coating, ink jet, lithographic, roll coating, curtain coating, etc.

Printability: The quality of the print was assessed, inspecting for defects.

$$1 = Severe defects$$

$$2 = Significant defects$$

$$3 = Minor defects$$

$$4 = Minimal defects$$

$$5 = No defects$$

Resolubility: Using an RK gravure flatbed printer, a layer of ink was applied to a 150 LPI block gravure etch. The ink was allowed to dry at room temperature for 10 minutes. Once dry, a single drop of ink was applied to the surface, allowed to stand for 30 s, then removed with a rag damped in the primary solvent of the ink. The level of ink removal was assessed.

$$1 = No removal$$

$$2 = Slight removal$$

$$3 = Partial removal$$

$$4 = Traces removal$$

$$5 = Complete removal$$

Block Resistance: The print was allowed to dry for one hour at room temperature then blocked, front to back, at 10 tons for 10 minutes, using a Specac bench top hydraulic press. The ease of separation of the two layers was assessed.

$$1 = Severe cling , significant damage$$

$$2 = Significant cling , slight damage$$

$$3 = Significant cling , no damage$$

$$4 = Slight cling , no damage$$

$$5 = No cling , no damage$$

Foam Control: Foaming was assessed by means of an air stone bubbler diffuser, aquarium pump and measuring cylinder. The ink was placed in the measuring cylinder with the air stone at the bottom. Air was blown through the ink for two minutes. The resultant foam was recorded as a percentage of the total volume.

$$1 = 80 to 100 \%$$

$$2 = 60 to 80 \%$$

$$3 = 40 to 60 \%$$

$$4 = 20 to 40 \%$$

$$5 = 0 to 20 \%$$

Adhesion: Adhesion was tested using Tesa 4104 tape.

$$1 = Complete removal$$

$$2 = Traces removal$$

$$3 = Partial removal$$

$$4 = Slight removal$$

$$5 = No removal$$

Cure Time: The time required to achieve de-metallization resistance. The prints were prepared and aged at room temperature, then tested in accordance with the De-metallization Test. The aging time required to give a de-metallization quality of 3 or higher was recorded.

$$1 = More than 24 hours$$

$$2 = 12 to 24 hours$$

$$3 = 1 to 12 hours$$

$$4 = Less than 1 hour$$

$$5 = Immediate resistance$$

De-metallization quality: Print was prepared and left to age at room temperature (e.g. 25° C.) for at least the required cure time, as identified by the Cure time method. In the case of examples 1, 4 & 5 the cure time used was one minute. The anionic inks in examples 2 & 3 were allowed to cure for 24 hours prior to testing. The print was then tested in accordance with the De-metallization Test.

De-metallization Test: The print was then immersed in 5M NaOH solution at 20° C., until all aluminum had been removed from the unprinted area, then rinsed with water. The required immersion time is dependent upon the grade of metallized material used. For aluminum metallized PET with an optical density of 2.1 the immersion time may be standardised at 20 seconds. The printed area was assessed for damage to aluminum layer.

$$1 = Complete removal$$

$$2 = Significant removal$$

$$3 = Significant edge erosion or pinhole damage ( visible by the naked eye )$$

$$4 = Slight edge erosion or pinhole damage ( visible by 10 \times magnification )$$

$$5 = No damage$$

For example, the composition of the invention, when gravure printed on aluminum metallized PET with an optical density of 2.1 using a 150 LPI stepped plate then aged at room temperature (e.g. 25° C.) for 1 minute, may provide a resist which scores 4 or 5 on the De-metallization test when the immersion time is 20 seconds.

VOC Emissions: The volatile organic content of the ink, as a proportion of the total volatile content.

$$1 = 95 to 100 \%$$

$$2 = 50 to 95 \%$$

$$3 = 10 to 50 \%$$

$$4 = 0 to 10 \%$$

$$5 = 0 \%$$

1. A method of protecting a metal surface from damage or removal during a de-metallization process, comprising printing a water-based resist composition onto a metal-coated filmic substrate, thereby protecting the metal surface from damage or removal during the de-metallization process, wherein the water-based resist composition comprises a cationic acid-soluble resin or cationic acid-stabilized resin, and water; wherein the method does not comprise exposing the resist composition to actinic or infrared (IR) radiation.

2. The method of claim 1, wherein the filmic substrate is aluminum-coated.

3. The method of claim 1 wherein the filmic substrate is a polymeric film.

4. The method of claim 1 where the de-metallization process is an alkaline de-metallization process.

5. A method of de-metallization, comprising following the method of claim 1, then subjecting the metal-coated filmic substrate to an alkaline de-metallization process.

6. (canceled)

7. The method of claim 1 wherein printing is gravure, flexographic or screen printing.

8. A method of printing on a metal-coated filmic substrate wherein said method comprises applying a water-based resist composition onto the substrate, wherein the water-based composition comprises a cationic acid-soluble resin or a cationic acid-stabilized resin and water, wherein the printing is gravure, flexographic or screen printing, and wherein the method does not comprise exposing the resist composition to actinic or infrared (IR) radiation.

9. (canceled)

10. (canceled)

11. (canceled)

12. (canceled)

13. (canceled)

14. The method according to claim 1 wherein the water-based resist composition comprises water, a cationic acid-soluble resin and a cationic acid-stabilized resin.

15. A water-based resist composition suitable for use as a resist in alkaline de-metallization processing, said composition comprising:
a cationic acid-soluble resin, a cationic acid-stabilized resin, or a combination thereof; and
water;
wherein the composition is not a photoresist activated by actinic or infrared radiation, and
wherein the composition does not comprise a crosslinking agent.

16. (canceled)

17. (canceled)

18. The composition of claim 15 which does not comprise a photoinitiator selected from a thioxanthone, phosphine oxide, quinine, benzophenone, benzoin, acetophenone, benzoin ether, benzil ketal or a combination thereof.

19. (canceled)

20. The composition of claim 15, wherein the composition includes an IR absorbing material selected from: carbon black, graphite, and combinations thereof, provided that the carbon black, graphite, and combinations thereof are not present in an amount of 5 to 50 wt % of the total weight of the composition.

21. The composition of claim 15, wherein the cationic acid-soluble resin or cationic acid-stabilized resin is solubilized or stabilized with acetic acid and/or formic acid.

22. (canceled)

23. The composition of claim 15 wherein the cationic acid-stabilized resin has a Tg≥50° C.

24. (canceled)

25. (canceled)

26. (canceled)

27. (canceled)

28. (canceled)

29. (canceled)

30. The composition of claim 15 comprising a cationic acid-soluble resin.

31. The composition of claim 15, wherein the cationic acid-soluble resin is a poly(amino alkyl acrylate) or a poly(amino alkyl methacrylate).

32. (canceled)

33. (canceled)

34. A printed article prepared by the method of claim 8 which is a security device.

35. (canceled)

36. A security article comprising the security device of claim 34, preferably wherein the security article is a banknote.

37. A security device comprising a metal-coated filmic substrate wherein the metal-coated filmic substrate comprises a resist layer derived from a water-based composition comprising water and a cationic acid-soluble resin or cationic acid-stabilized resin.

38. (canceled)

39. The composition of claim 15, wherein the composition includes an IR absorbing material selected from one or more organic compound(s) selected from poly-(substituted)-phthalocyanine compounds, cyanine dyes, squarylium dyes, chalcogenopyryloarylidene dyes, bis-(chalcogenopyrylo)polymethine dyes, oxyindolizine dyes, bis(aminoaryl)polymethine dyes), merocyanine dyes, quinoid dyes, indolenine dyes, indocyanine dye and combinations thereof, provided that the organic compound(s) are not present in an amount of 0.1 to 10 wt % of the total weight of the composition.

40. The composition of claim 15, wherein the composition does not include an IR absorbing material selected from: carbon black, graphite, and combinations thereof; or organic compound(s) selected from poly-(substituted)-phthalocyanine compounds, cyanine dyes, squarylium dyes, chalcogenopyryloarylidene dyes, bis-(chalcogenopyrylo)polymethine dyes, oxyindolizine dyes, bis(aminoaryl)polymethine dyes), merocyanine dyes, quinoid dyes, indolenine dyes, indocyanine dye and combinations thereof.

41. A printed article prepared by the method of claim 14, which is a security device.
